(19) United States
(12) Patent Application Publication
(10) Pub. No.: US 2006/0220572 A1
(43) Pub. Date: Oct. 5, 2006

(54) Driving device of luminescent display panel and driving method of the same

(75) Inventor: Shuichi Seki, Yonezawa-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOHOKU PIONEER CORPORATION, Tendo-shi (JP)

(21) Appl. No.: 11/373,091

(22) Filed: Mar. 13, 2006

(30) Foreign Application Priority Data
Mar. 29, 2005 (JP) 2005-094883

(51) Int. Cl. H05B 39/04

(52) U.S. Cl. 315/100

(57) ABSTRACT

A driving device 100 of a luminescent display panel in which luminescent elements 14 each having luminescence controlled by a luminescence driving transistor 12 are arranged at intersecting positions of a plurality of data lines and a plurality of scanning lines and in which pixels each including a plurality of sub-pixels 30 having different luminescent colors are arranged at the luminescent elements 14, includes: scanning means 25 that scans all of the pixels formed on the luminescent display panel by scanning the sub-pixels during a plurality of sub-pixel scanning periods set at different timings for the respective luminescent colors in one frame period or in respective sub-frame periods formed by time-dividing the one frame period; and color balance controlling means 21 that controls a ratio of relative luminescence times of the respective different luminescent colors in the sub-pixel scanning period.

### BACKGROUND OF THE INVENTION

1. Field of the Invention

The present invention relates to a driving device of a luminescent display panel in which spontaneous luminescent elements having luminescence controlled by luminescence driving means are arranged at the intersecting positions of a plurality of data lines and a plurality of scanning lines and in which pixels each including a plurality of sub-pixels having different luminescent colors are arranged at the respective spontaneous luminescent elements, and a driving method of the same.

2. Description of the Related Art

Developments are being widely made in a display using a display panel constructed of luminescent elements arranged in the shape of a matrix. An organic EL (electroluminescence) element using an organic material as a luminescent layer has received attention as a luminescent element used for such a display panel.

One of display panels using such organic EL elements is an active matrix type display panel (refer to Japanese Unexamined Patent Publication No. 2003-316315) in which each of the EL elements arranged in the shape of a matrix has an active element made of, for example, a TFT (Thin Film Transistor) additionally mounted. This active matrix type display panel can realize low power consumption and has a feature that cross talk is scarce between pixels and is suitably applied particularly to a high-definition display constructing a large screen.

FIG. 1 shows one example of a circuit construction corresponding to one pixel 10 in a conventional active matrix type display panel. In FIG. 1, the gate G of a TFT 11 of a transistor for control is connected to a scanning line (scanning line A) and a source S is connected to a data line (data line B1). The drain D of this TFT 11 of a transistor for control is connected to the gate G of a TFT 12 of a transistor for driving luminescence (luminescence driving means) and is connected to one terminal of a capacitor 13 for holding electric charges.

The drain D of the TFT 12 for driving is connected to the other terminal of the capacitor 13 and to a common anode 16 formed in a panel. The source S of the TFT 12 for driving is connected to the anode of an organic EL element 14 and the cathode of this organic EL element 14 is connected to a common cathode 17 constructing, for example, a reference potential point (earth) formed in the panel.

FIG. 2 schematically shows a state in which circuit constructions including the respective pixels 10 shown in FIG. 1 are arranged in a display panel 20 and the respective pixels 10 each having the circuit construction shown in FIG. 1 are formed at the respective intersecting positions of the respective scanning lines A1 to An and the respective data lines B1 to Bm. In the above-mentioned construction, the drains of the respective TFTs 12 for driving are connected to the common anode 16 (driving power source) shown in FIG. 2 and the cathodes of the respective EL elements 14 are connected to the common cathode 17 shown in FIG. 2. In this circuit, in the case of performing the control of luminescence, the positive power terminal of a voltage source E1 is connected to the common anode 16 formed on the display panel via a switch 18 and the negative power terminal of the voltage source E1 is connected to the common cathode 17.

When an on voltage is supplied to the gate G of the TFT 11 for control in FIG. 1 via the scanning line in this state, the TFT 11 passes current, which corresponds to a data voltage supplied to the source S from a data line, from the source S to the drain D. Hence, the capacitor 13 is charged for a period during which the gate G of the TFT 11 is at the on voltage, and its voltage is supplied to the gate G of the TFT 12 for driving, and the TFT 12 passes current based on its gate voltage and drain voltage from the source S to the common cathode 17 via the EL element 14, thereby causing the EL element to luminesce.

When the gate G of the TFT 11 is brought to off voltage, the TFT 11 is brought to the so-called cut-off state and hence the drain D of the TFT 11 is brought to an open state, but the TFT 12 for driving has voltage applied to its gate G held by the electric charges stored in the capacitor 13 to keep the driving current until the next scanning, thereby also causing the EL element 14 to keep luminescing. Because the above-mentioned TFT 12 for driving has gate input capacity, even if the TFT 12 for driving is not particularly provided with the capacitor 13, the TFT 12 can perform the same operation described above.

The display panel 20 having its respective pixels formed of the organic EL elements can construct a display panel of monochrome luminescence or a display panel of color luminescence. In the display panel of color luminescence, each pixel is constructed of two or more spontaneous luminescent elements each having luminescent function layers luminescing in different colors. In general, three pixels 10 (hereinafter referred to as “sub-pixel”) made of the organic elements corresponding to three colors, that is, red (R), green (G), and blue (B) are arranged on the same scanning line to construct one color pixel 1. In this case, the drains D of the TFTs 12 for driving in the respective sub-pixels 10 are respectively connected to the anodes 16a, 16b, and 16c (driving power source) provided for respective luminescent colors.

By the way, in the case of producing a color display by the EL elements, there is presented a problem that when voltage drive is used for controlling the luminescence of the elements, variations in luminance are caused by a difference in luminescence efficiency between the respective elements of red (R), green (G), and blue (B) to make it difficult to achieve an appropriate color balance (white balance). For this reason, although the control of luminescence is commonly performed by the use of current drive, the ratio of luminescence efficiency of R, G, and B becomes, for example, approximately R:G:B=3:6:1 for a constant current and hence contrivance to achieve a color balance (white balance) is made by setting appropriate reference currents for the respective luminescent colors.

As described above, conventionally, contrivance to achieve a color balance (white balance) is made by setting appropriate reference currents for the respective luminescent colors. Adjusting circuits for setting the reference currents and for adjusting luminance are provided for the respective luminescent colors and luminance is adjusted in accordance with the luminescent material of the organic EL element by the adjusting circuits corresponding to the respective luminescent colors.

In recent years, various kinds of luminescent materials have been developed but these new luminescent materials are very different from each other in luminescent characteristics relating to current or luminescent characteristics relating to temporal change. Hence, there are cases where depending on the material, the conventional adjusting circuit cannot adjust luminance with high accuracy because the dynamic range of luminance adjustment is narrow.

Moreover, to adjust luminance with high accuracy for the luminescent material to which the conventional adjusting circuit cannot respond, it is necessary to make the dynamic range in the adjusting circuit wider than usual. However, when the dynamic ranges are made wider, the adjusting circuits of R, G, and B are made larger in size. This raises a problem that it is difficult to form a current driving circuit of one chip IC. As a result, this leads to a problem that it is impossible to respond to a request to downsize a display driving circuit.

### SUMAMRY OF THE INVENTION

This invention has been made in view of the above-mentioned technical problems. The object of this invention is to provide a driving device of a luminescent display panel the type in which luminescent elements having luminescence controlled by luminescence driving means are arranged at intersecting positions of a plurality of data lines and a plurality of scanning lines, the luminescent element having a pixel including a plurality of sub-pixels having different luminescent colors, and which can prevent an increase in the size of a circuit of a display system and can achieve an appropriate color balance (white balance), and a driving method of the same.

A driving device of a luminescent display panel in accordance with the present invention to solve the above-mentioned problems is a driving device of a luminescent display panel of the type in which luminescent elements each having luminescence controlled by luminescence driving means are arranged at intersecting positions of a plurality of data lines and a plurality of scanning lines and in which pixels each including a plurality of sub-pixels having different luminescent colors are arranged at the respective luminescent elements, and is characterized by including: scanning means that scans all of the pixels formed on the luminescent display panel by scanning the sub-pixels during a plurality of sub-pixel scanning periods set at different timings for the respective luminescent colors in one frame period or in respective sub-frame periods formed by time-dividing the one frame period; and color balance controlling means that controls a ratio of relative luminescence times of the respective different luminescent colors in the sub-pixel scanning period.

Moreover, a driving device of a luminescent display panel in accordance with the present invention is a driving device of a luminescent display panel of the type in which luminescent elements each having luminescence controlled by a luminescence driving transistor are arranged at intersecting positions of a plurality of data lines and a plurality of scanning lines and in which pixels each including a plurality of sub-pixels having different luminescent colors are arranged at the luminescent elements, and is characterized by including: scanning means that scans the sub-pixels of all of the different luminescent colors at a same start timing of scanning in the respective sub-frame periods formed by time-dividing one frame period, thereby scanning all of the pixels formed on the luminescent display panel; a transistor for erasing that discharges and erases electric charges from a capacitor holding a gate potential of the luminescence driving transistor; and color balance controlling means that discharges the electric charges of the capacitor by the transistor for erasing to stop the luminescent element from luminescing to set a non-luminescence period of the luminescent element in the respective sub-frame periods, thereby controlling a ratio of relative luminescence times of the respective different luminescent colors in the respective sub-pixel scanning periods.

Further, a driving device of a luminescent display panel in accordance with the present invention is a driving device of a luminescent display panel of the type in which luminescent elements each having luminescence controlled by a luminescence driving transistor are arranged at intersecting positions of a plurality of data lines and a plurality of scanning lines and in which pixels each including a plurality of sub-pixels having different luminescent colors are arranged at the luminescent elements, and is characterized by including: luminescence stop controlling means that stops the luminescent element from luminescing by using a transistor for erasing that discharges and erases electric charges from a capacitor holding a gate potential of the luminescence driving transistor; data supply controlling means that applies a data voltage to the data lines corresponding to the sub-pixels having different luminescent colors, which construct a same pixel, at different timings for respective luminescent colors in respective sub-frame periods formed by time-dividing one frame period; and color balance controlling means that stops the luminescent elements of the sub-pixels of the respective different luminescent colors from luminescing by the luminescence stop controlling means when the respective sub-frame periods start to thereby set a non-luminescence period of the pixel when the respective sub-frame periods start, and controls timing of applying the data voltage by the data supply control means to cause the sub-pixels to start to luminesce for the respective luminescent colors, thereby controlling a ratio of relative luminescence times of the respective different luminescent colors in the respective sub-frame periods.

Still further, a driving method of a luminescent display panel in accordance with the present invention to solve the above-mentioned problems is a driving method of a luminescent display panel of the type in which luminescent elements each having luminescence controlled by luminescence driving means are arranged at intersecting positions of a plurality of data lines and a plurality of scanning lines and in which pixels each including a plurality of sub-pixels having different luminescent colors are arranged at the luminescent elements, is characterized by performing the steps of: scanning all of the pixels formed on the luminescent display panel by setting a plurality of sub-pixel scanning periods, during which the sub-pixels are scanned for respective different luminescent colors, at different timings in one frame period or in respective sub-frame periods formed by time-dividing the one frame period; and controlling a ratio of relative luminescence times of the respective different luminescent colors in the sub-pixel scanning period.

Still further, a driving method of a luminescent display panel in accordance with the present invention is a driving method of a luminescent display panel of the type in which luminescent elements each having luminescence controlled by a luminescence driving transistor are arranged at intersecting positions of a plurality of data lines and a plurality of scanning lines and in which pixels each including a plurality of sub-pixels having different luminescent colors are arranged at the luminescent elements, and is characterized by performing the steps of: scanning the sub-pixels of all of the different luminescent colors at a same start timing of scanning in the respective sub-frame periods formed by time-dividing one frame period, thereby scanning all of the pixels formed on the luminescent display panel; and stopping the luminescent element from luminescing for the respective different luminescent colors by a transistor for erasing that discharges and erases electric charges from a capacitor holding a gate potential of the luminescence driving transistor in the respective sub-frame periods, thereby setting a non-luminescence period, and thereby controlling a ratio of relative luminescence times of the respective different luminescent colors in the respective sub-pixel scanning periods.

Still further, a driving method of a luminescent display panel in accordance with the present invention is a driving method of a luminescent display panel of the type in which luminescent elements each having luminescence controlled by a luminescence driving transistor are arranged at intersecting positions of a plurality of data lines and a plurality of scanning lines and in which pixels each including a plurality of sub-pixels having different luminescent colors are arranged at the luminescent elements, and is characterized by performing the steps of: stopping the luminescent elements of the sub-pixels of the respective different luminescent colors from luminescing at a same time by using a transistor for erasing that discharges and erases electric charges from a capacitor holding a gate potential of the luminescence driving transistor when the respective sub-frame periods formed by time-dividing one frame period start, thereby setting a non-luminescence period of the pixel when the respective sub-frame periods start; and controlling timing of applying a data voltage to data lines corresponding to the respective different luminescent colors for the sub-pixels of respective different luminescent colors, which construct a same pixel, in the respective sub-frame periods, thereby causing the sub-pixels to start to luminesce for the respective luminescent colors, and thereby controlling a ratio of relative luminescence times of the respective different luminescent colors in the respective sub-frame periods.

### BRIEF DESCRIPTION OF THE DRAWINGS

FIG. 1 is a diagram showing one example of a circuit construction corresponding to one pixel in a conventional active matrix type display panel;

FIG. 2 is a diagram schematically showing a state in which the circuit constructions including the respective pixels shown in FIG. 1 are arranged on a display panel;

FIG. 3 is a diagram showing the arrangement of sub-pixels of three colors in one pixel in which the sub-pixel has the pixel construction shown in FIG. 1;

FIG. 4 is a block diagram showing a first embodiment in accordance with a driving device of the present invention;

FIGS. 5A and 5B are diagrams showing the relationship between a sub-frame period and a method for displaying gradation in one frame period;

FIG. 6 is a diagram showing the arrangement of sub-pixels of three colors constructing one pixel in the first embodiment of the driving device shown in FIG. 4;

FIG. 7 is a diagram schematically showing the state of arrangement of a whole display panel in the arrangement of pixels shown in FIG. 6;

FIGS. 8A and 8B are diagrams showing scanning timings in one frame period in the driving device shown in FIG. 4;

FIGS. 9A and 9B are diagrams showing another mode of scanning timings in one frame period in the driving device shown in FIG. 4;

FIG. 10 is a block diagram showing a second embodiment in accordance with a driving device of the present invention;

FIG. 11 is a diagram showing one example of a circuit construction corresponding to one pixel in the driving device shown in FIG. 10;

FIGS. 12A and 12B are diagrams showing scanning timings in one frame period in the driving device shown in FIG. 10;

FIG. 13 is a diagram showing the arrangement of sub-pixels of three colors constructing one pixel in a third embodiment in accordance with a driving device of the present invention;

FIG. 14 is a diagram showing scanning timings in one frame period in the third embodiment in accordance with a driving device of the present invention;

FIG. 15 is a diagram showing the arrangement of sub-pixels of three colors constructing one pixel in a fourth embodiment in accordance with a driving device of the present invention; and

FIG. 16 is a diagram showing scanning timings in one frame period in the fourth embodiment in accordance with a driving device of the present invention.

### DETAILED DESCRIPTION OF THE PREFERRED EMBODIMENTS

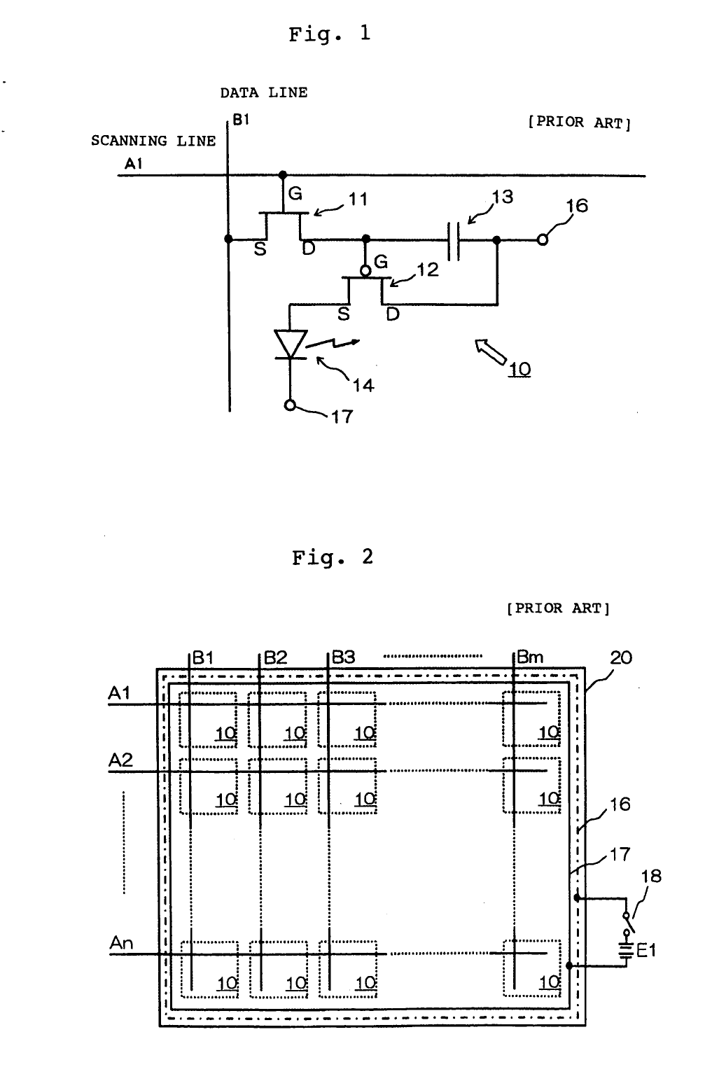

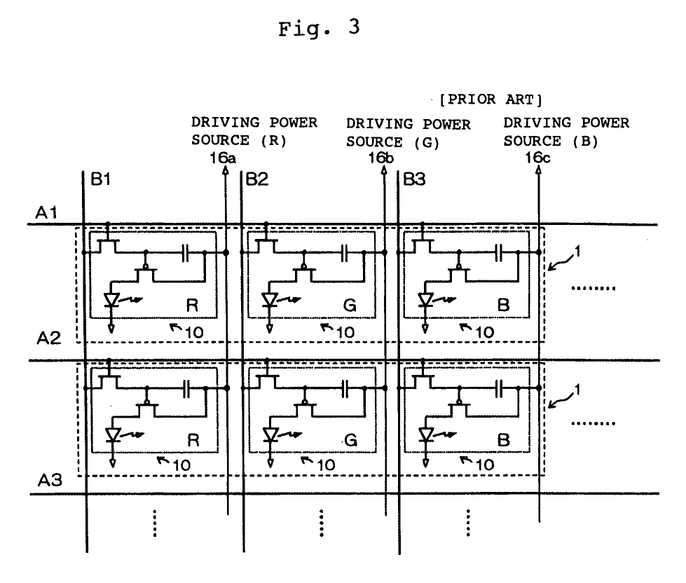

Hereinafter, a driving device of a luminescent display panel in accordance with the present invention and a driving method of the same will be described on the basis of the preferred embodiments shown in the drawings. In the following description, parts corresponding to the respective parts already described and shown in FIG. 1 and FIG. 2 are denoted by the same reference symbols and hence the descriptions of their individual functions and operations will be omitted as appropriate.

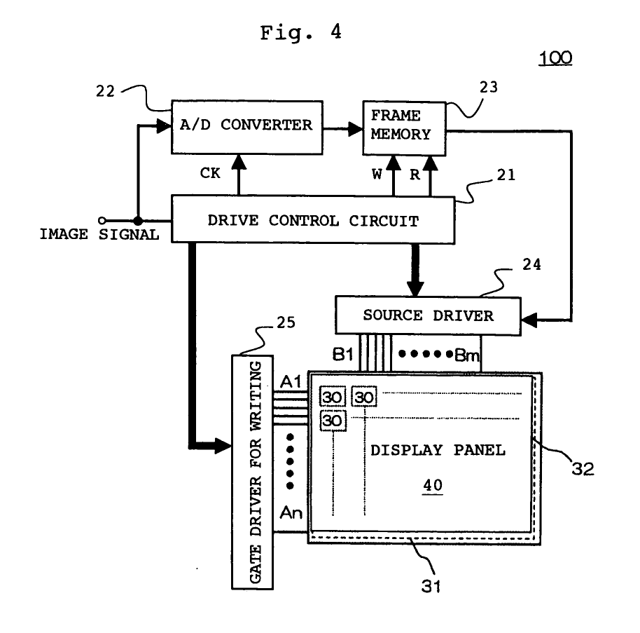

FIG. 4 is a block diagram showing a first embodiment in a driving device and a driving method in accordance with the present invention. In a driving device 100 shown in FIG. 4, a drive control circuit 21 controls the operations of a source driver 24 and a gate driver 25 for writing, and these drivers drive a luminescent display in a display panel 40 constructed of pixels 30 arranged in the shape of a matrix.

In the driving device 100 shown in FIG. 4, first, an inputted analog image signal is supplied to the drive control circuit 21 and an analog/digital (A/D) converter 22. The drive control circuit 21 produces a clock signal CL to the A/D converter 22 and a writing signal W and a reading signal R to a frame memory 23 on the basis of a horizontal synchronous signal and a vertical synchronous signal in the analog image signal.

The A/D converter 22 samples the inputted analog image signal on the basis of the clock signal CK supplied from the drive control circuit 21 and converts the inputted analog image signal to pixel data corresponding to one pixel and supplies the converted pixel data to the frame memory 23. The frame memory 23 sequentially writes the respective pixel data supplied from the A/D converter 22 to the frame memory 23 by the writing signal W supplied from the drive control circuit 21.

When writing the data of one screen (n columns and m rows) in the spontaneous luminescent display panel 40 is finished by this writing operation, the frame memory 23 sequentially supplies the source driver 24 with drive pixel data read every one column from the first column to the n-th column by the reading signal R supplied from the drive control circuit 21.

Meanwhile, at the same time, the drive control circuit 21 sends a timing signal to the gate driver 25 for writing and the gate driver 25 as scanning means sequentially sends a gate-on voltage to respective scanning lines on this timing signal, as will be described later. Hence, the drive pixel data read in the above-mentioned manner from the frame memory 23 every one column is addressed by scanning by the gate driver 25.

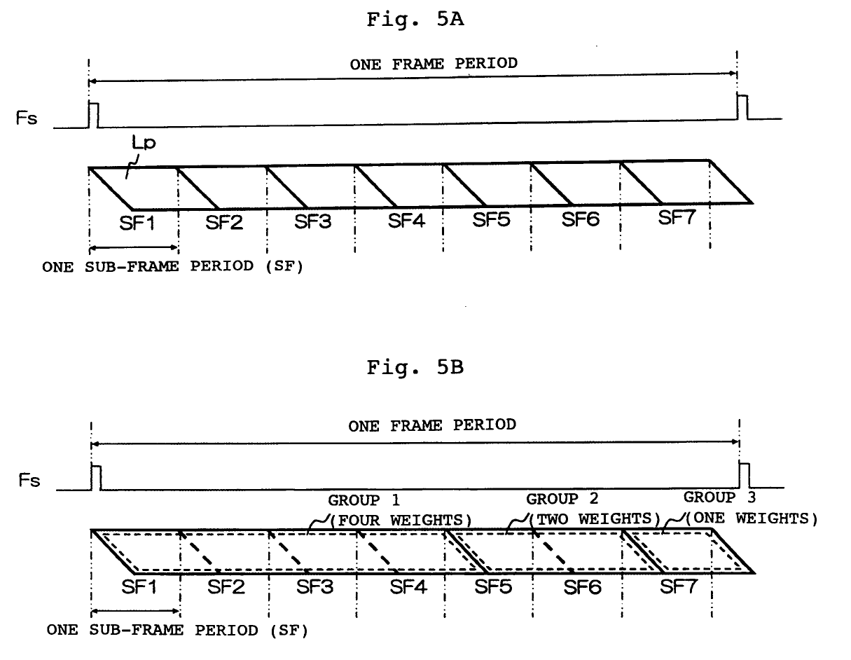

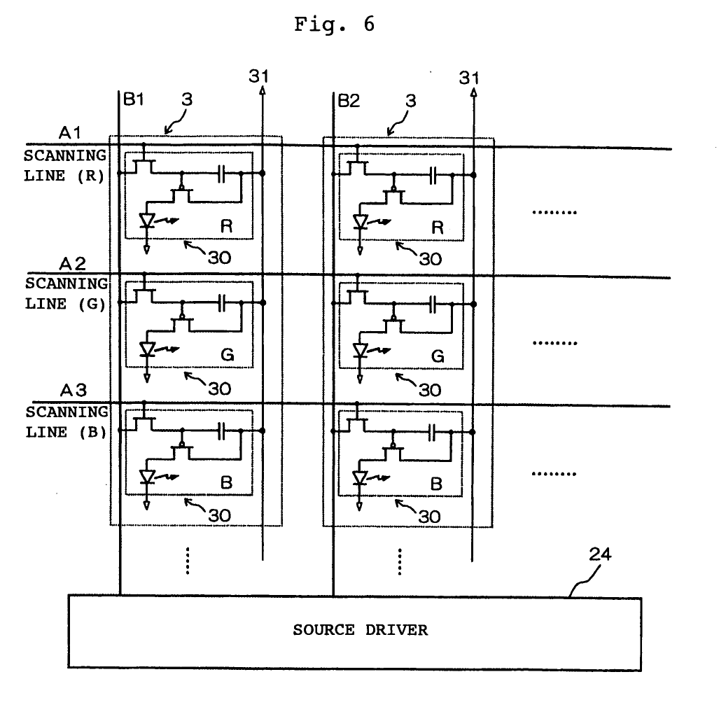

The above-mentioned circuit construction can change a time spent in supplying a driving current to an organic EL element of a spontaneous luminescent element (luminescence time) and hence can control the substantial luminance of the organic EL element 14. For example, as shown in FIG. 5A, if it is assumed that one frame period determined by a frame synchronous signal Fs is time-divided into seven sub-frame periods (SF1 to SF7) which are equal in period, 8 levels of gradation can be expressed by selecting an appropriate luminescent period Lp of the element in the sub-frame period or a combination of the luminescent periods Lp (simple sub-frame method).

Alternatively, as shown in FIG. 5B, gradation can be also expressed by assigning weights to groups of one sub-frame period or a plurality of sub-frame periods (group 1 to group 3) (assigning four weights to group 1, two weights to group 2, and one weight to group 3) and by selecting a combination of the groups (weighting sub-frame method). Among these, the weighting sub-frame method has the advantage of being able to realize multiple levels of gradation by the sub-frames of the number greatly smaller than in the simple sub-frame method. Such expression of gradation can be realized by gradation display means constructed of the drive control circuit 21, the source driver 24, the gate driver 25 for writing, and the respective pixels 30.

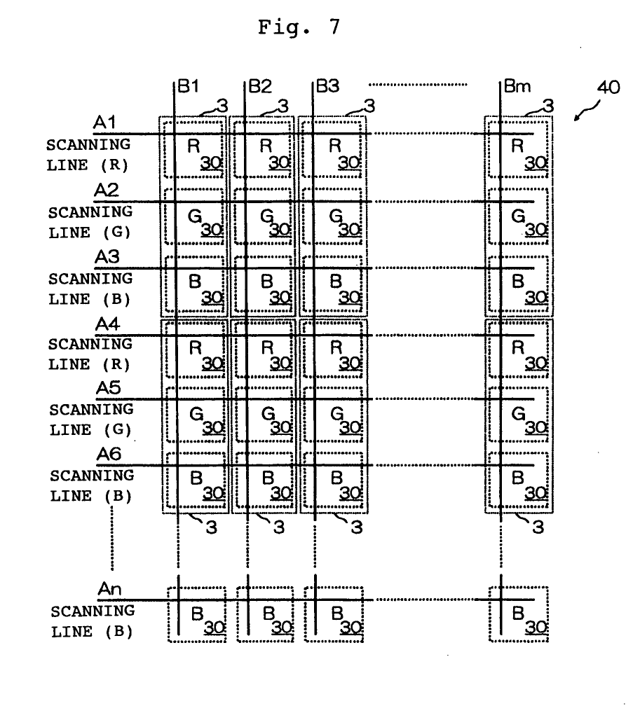

FIG. 6 is a diagram showing the construction of sub-pixels 30 arranged in the shape of a matrix in the luminescent display panel 40. In one embodiment of the present invention, as shown in the drawing, a sub-pixel 30 of red (R), a sub-pixel 30 of green (G), and a sub-pixel 30 of blue (B), which construct a color pixel 3, are connected to a common data line (shown by B1 in the drawing) and are arranged in a longitudinal direction and are connected to different scanning lines (shown by A1, A2, and A3 in the drawing). That is, sub-pixels of only any one of colors R, G, and B are arranged for one scanning line in a lateral direction, and as shown in FIG. 7, these scanning lines are repeatedly arranged in order of the scanning line of R, the scanning line of G, and the scanning line of B.

The drains D of the TFTs 12 for driving in the sub-pixels 30 of the respective luminescent colors are connected to a common anode 31 (driving power source). This is because a white balance (color balance) is achieved by passing a forward common current through the luminescent elements of the respective luminescent colors and by adjusting the ratio of relative luminescence times of the respective luminescent colors.

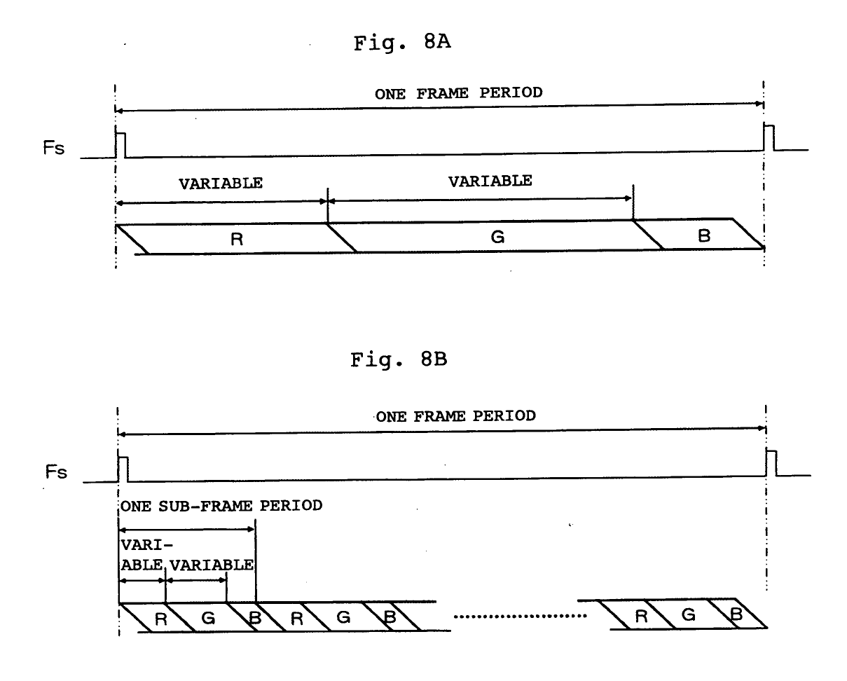

The driving device 100 performs scanning control to the display panel 40 constructed in this manner according to a timing chart, for example, shown in FIG. 8. FIG. 8A is a timing chart when a color balance is achieved for each frame period and FIG. 8B is a timing chart when a color balance is adjusted for each sub-frame period. As shown in FIG. 8, in one frame period or in each sub-frame period, first, the scanning line of R (red) in the display panel 40 is scanned and then the scanning line of G (green) is scanned at a specified timing. At this time, black data is written (control of stopping luminescence) to the sub-pixels 30 on the scanning line of R (red) in accordance with the timing just before starting scanning the scanning line of G (green).

When the scanning line of G (green) is scanned, the scanning line of B (blue) is then scanned at a specified timing. At this time, black data is written to the sub-pixels 30 on the scanning line of G (green) in accordance with the timing just before starting scanning the scanning line of B (blue). Further, black data is written to the sub-pixels 30 on the scanning line of B (blue) in accordance with the timing just before starting scanning the scanning line of R (red) of the next frame or the next sub-frame. In this manner, in one frame period or in one sub-frame period, periods during which only the sub-pixel of each of R (red), G (green), and B (blue) luminesce (sub-pixel scanning period) are formed at different timings and hence a color display for each frame period or for each sub-frame period can be realized.

The specified timings when the operations of scanning the scanning line of G (green) and the scanning line of B (blue) are started are controlled by the drive control circuit 21 (color balance controlling means) in such a way that the lengths of luminescence periods of R (red), G (green), and B (blue) in one frame period or in the respective sub-frame period are brought into an optimum white balance (color balance).

That is, the EL elements of respective colors are made to luminesce for the scanning periods of the sub-pixels of the respective luminescent colors (sub-pixel scanning periods) set at different timings and the start timings of scanning is controlled in such a way that the ratio of relative luminescence times of the respective luminescent colors becomes an optimum white balance (color balance). The drive control circuit 21 is supplied with luminance information with respect to a specified current acquired, for example, from monitor elements (not shown) corresponding to the respective luminescent colors, and scanning timings for achieving a white balance are controlled on the basis of the luminance information.

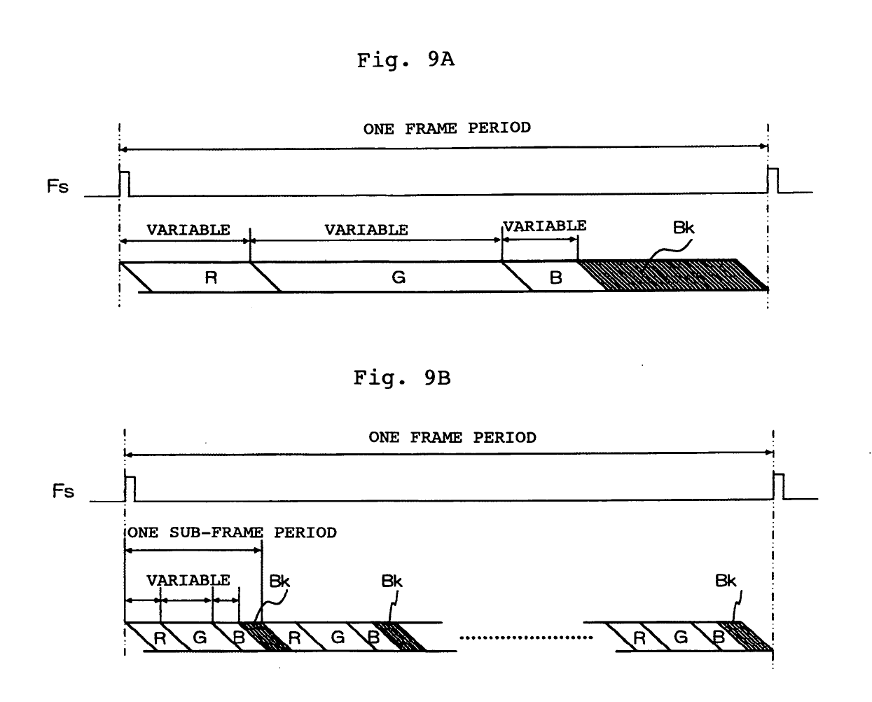

In this regard, in the timing control shown in FIG. 8, the total sum of the lengths of the sub-pixel scanning periods of the respective luminescent colors (luminescence periods of the respective luminescent colors) is equal to one frame period or one sub-frame period and hence absolute luminance cannot be adjusted by a method other than a method for controlling the value of a driving current. Hence, as a method for controlling absolute luminance without changing the value of the driving current supplied to the respective sub-pixels, control may be performed according to scanning timings, for example, shown in FIG. 9. FIG. 9A is a timing chart when a color balance is achieved for each frame period and FIG. 9B is a timing chart when a color balance is achieved for each sub-frame period. According to the control of scanning timing shown in FIG. 9, in one frame period or in each sub-frame period, the ratio of relative luminescence times of the respective colors of R, G, and B is always kept at a ratio to achieve an optimum white balance and the luminescence periods of all of the pixels can be varied. A display period of black data (non-luminescence period) is set after finishing the luminescence period. That is, the length of luminescence periods of all of the pixels (R, G, and B) in one frame period or in one sub-frame period (total sum of the lengths of the sub-pixel scanning periods of the respective luminescent colors) becomes shorter than the length of one frame period or one sub-frame period, and the luminance of the whole panel can be adjusted by controlling this length.

As described above, according to the first embodiment in accordance with the present invention, in each frame period or in each sub-frame period, the luminescence periods (sub-pixel scanning periods) of the EL elements of R (red), G (green), and B (blue) are set at different timings and an optimum white balance can be achieved by adjusting the lengths of the respective luminescence periods. Moreover, according to the above-mentioned construction, the forward current supplied to the sub-pixels of R, G, and B can be made common and the sub-pixels 30 of R, G, and B are connected to a common data line in the respective color pixels. Hence, this makes it possible to eliminate the need for providing such a circuit for adjusting a reference current that is used in a conventional technology and to construct a power supply system of a single system and to cause one data line to respond to one color pixel. Therefore, it is possible to reduce the scale of the circuit of a display control system.

In this regard, in the above-mentioned first embodiment, the display panel in which the luminescent elements in the respective pixels are the organic EL elements has been described by way of an example. However, it is not intended to limit the application of the driving device and the driving method of the present invention to this. That is, even if a display panel uses the luminescent elements other than the organic EL elements, if it is a display panel of the type producing a temporal gradation display by the use of the sub-frame period, the driving device and the driving method of the present invention can be suitably applied to the display panel.

Successively, a second embodiment of the driving device and the driving method of a luminescent display panel in accordance with the present invention will be described.

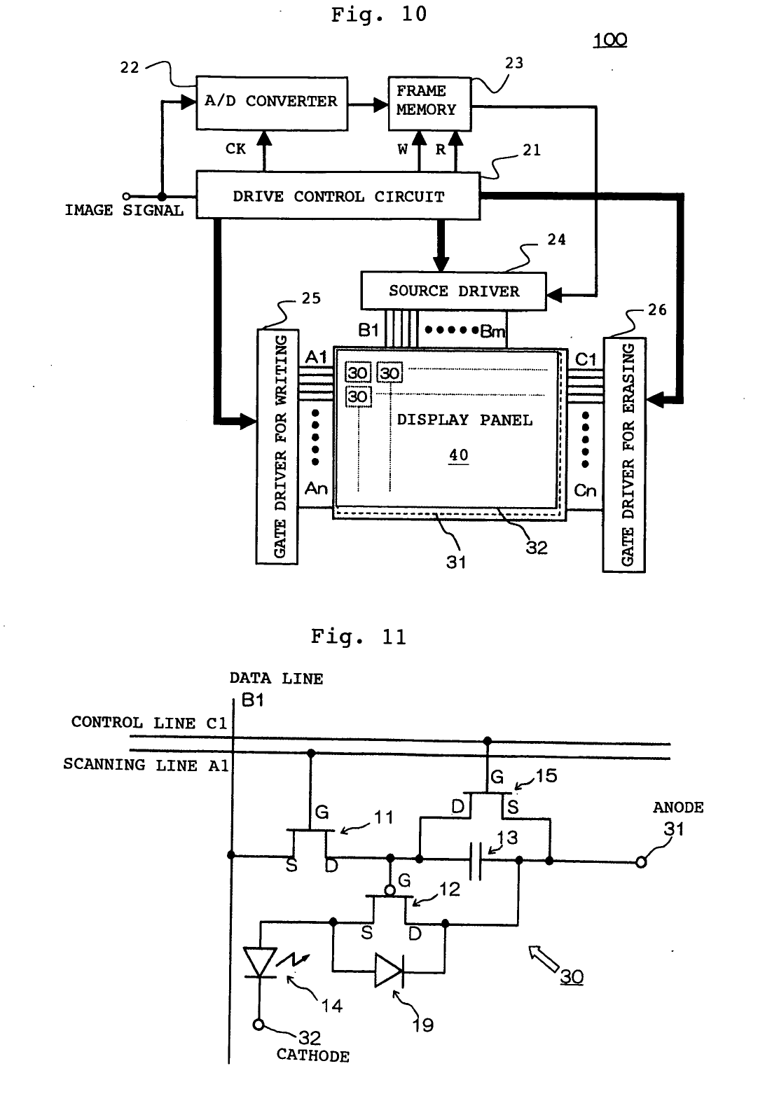

FIG. 10 is a block diagram showing the second embodiment of the driving device and the driving method of a luminescent display panel in accordance with the present invention. FIG. 11 is a circuit diagram showing an example of a circuit construction of one pixel of pixels 30 arranged in the shape of a matrix on the display panel 40 shown in FIG. 10. The construction shown in FIG. 10 is a construction in which a gate driver 26 for erasing is added to the construction shown in FIG. 4 in the first embodiment. The construction shown in FIG. 11 is a construction in which a TFT (transistor) 15 for erasing that erases electric charges stored in the capacity 13 is added to the pixel construction in the first embodiment. Hence, in the following description, parts corresponding to the respective parts shown in FIGS. 1, 2, 4, and 6, which have been already described, are denoted by the same reference symbols and hence the description of their individual functions and operations will be omitted as appropriate. Also in this second embodiment, it is assumed that the sub-pixels of the respective colors, which construct one color pixel, are arranged on different scanning lines just as with the first embodiment.

As shown in FIG. 10, the gate driver 26 for erasing, which has its operation controlled by the driving control circuit 21, is provided with control lines C1 to Cn connected to the respective pixels of the display panel 40. These control lines C, as shown in FIG. 11, are so constructed as to supply control signals (on/off signals) to the gates of the TFTs 15 for erasing. That is, the gate driver 26 for erasing receives the control signal from the driving control circuit 21 and selectively applies a specified level of voltage to the control lines C1 to Cn arranged electrically separately from each other for each scanning line to control the operations of turning on/off the TFTs 15 for erasing.

The TFT 15 for erasing is connected in parallel to the capacitor 13 and when the TFT 15 for erasing is turned on according to the control signal from the driving control circuit 21 while the organic EL element 14 is luminescing, the TFT 15 for erasing can instantaneously discharge the electric charges in the capacitor 13. With this, the TFT 15 for erasing can stop the pixel from luminescing until the next addressing.

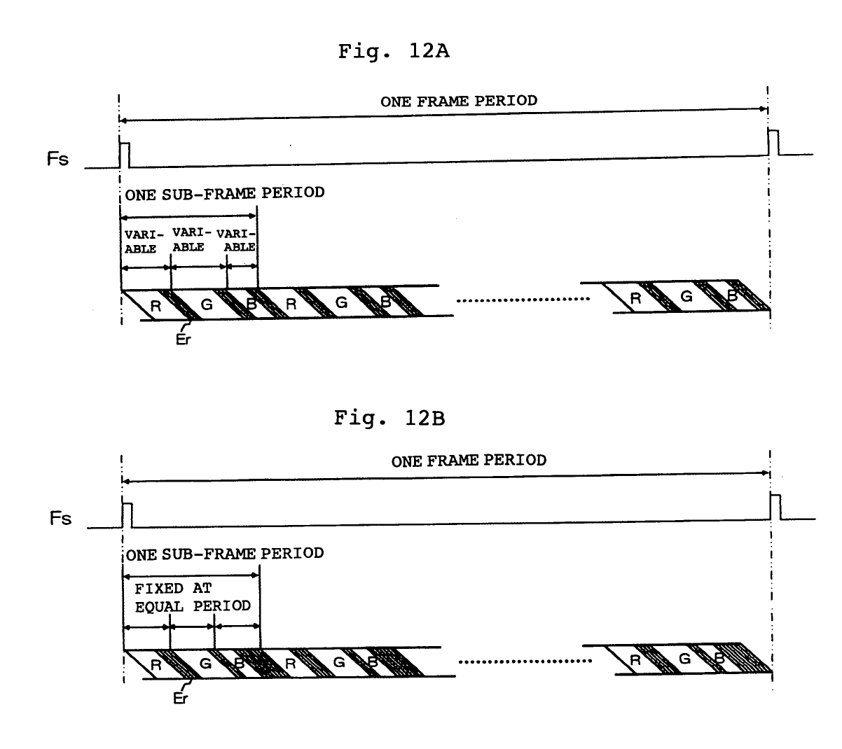

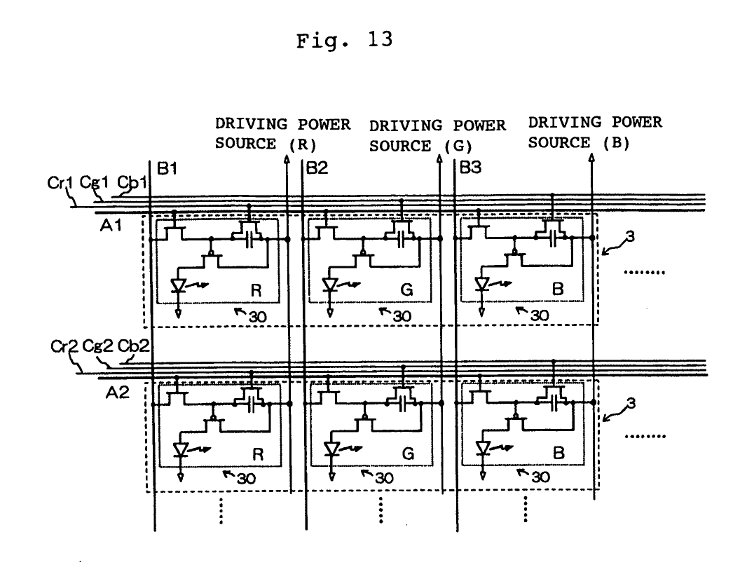

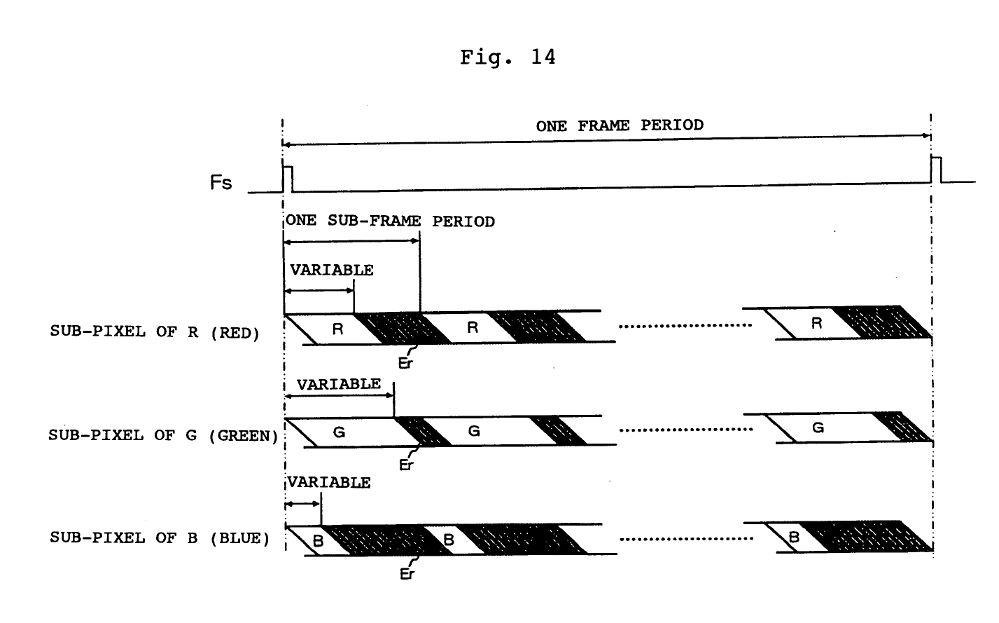

The driving device 100 performs scanning control to the display panel 40 constructed in this manner according to a timing chart shown, for example, in FIG. 12. In an example, shown in FIG. 12A, one frame period is divided into sub-frame periods at equal time intervals. In each sub-frame period, the scanning line of R (red) in the display panel 40 is first scanned and the scanning line of G (green) is then scanned at a specified timing. When the scanning line of G (green) is scanned, the scanning line of B (blue) is then scanned at a specified timing.

The specified start timings of scanning the scanning line of G (green) and the scanning line of B (blue) are controlled by the driving control circuit 21 (cooler balance controlling means) in such a way that the ratio of relative luminescence times of colors of R (red), G (green), and B (blue) in each sub-frame period becomes an optimum white balance (color balance).

That is, in each sub-frame period, first, a luminesce ratio in which the relative ratio of lengths of scanning periods of the sub-pixels of the respective colors (sub-pixel scanning periods) becomes an optimum white balance (color balance) is set, and a non-luminescence period Er of an equal period irrespective of luminescent colors is set after the luminesce period of each sub-pixel scanning period. That is, this non-luminescence period Er can be realized by the action that the TFT 15 for erasing erases the electric charges in the capacitor 13 according to the control signal from the gate driver for erasing. By equalizing the non-luminescence periods Er in the respective sub-pixel scanning periods, the white balance is not thrown out of balance but can be kept, and by controlling the length of the non-luminescence period Er, the luminance of the whole panel can be adjusted. The driving control circuit 21 is supplied with luminance information with respect to a specified current obtained from monitor elements (not shown) corresponding to the respective colors and controls scanning timings for achieving a white balance on the basis of the luminance information.

In an example shown in FIG. 12B, one frame period is time-divided into sub-frame periods of equal time intervals and each sub-frame period is time-divided into three sub-pixel scanning periods of equal time intervals. In each sub-frame period, the scanning line of R (red) is scanned in the sub-pixel scanning period of R (red), and the scanning line of G (green) is scanned in the sub-pixel scanning period of G (green), and the scanning line of B (blue) is scanned in the sub-pixel scanning period of B (blue).

In the respective sub-pixel scanning periods, as shown in the drawing, specified non-luminescence periods Er are set. That is, the non-luminescence period Er is realized by the action that the TFT 15 for erasing erases the electric charges in the capacitor 13 according to the control signal from the gate driver for erasing. Timings when the non-luminescence periods Er are set are determined by the driving control circuit 21 (cooler balance controlling means) in such a way that the ratio of relative luminescence times of colors of R (red), G (green), and B (blue) in one sub-frame period becomes an optimum white balance (color balance). According to the control of scanning timings shown in FIG. 12B, the luminance of the whole display panel can be adjusted by controlling the relative ratio of the non-luminescence periods Er set in the respective sub-pixel scanning periods to a constant value (controlling also the relative ratio of the respective luminescence periods to a constant value) and by variably controlling the lengths of the non-luminescence periods Er in the sub-pixels of the respective colors.

As described above, according to the second embodiment in accordance with the present invention, in the respective frame periods or in the respective sub-frame periods, the luminescence periods of the EL elements of R (red), G (green), and B (blue) are set at different timings, and an optimum white balance can be achieved by adjusting the lengths of the respective luminescence periods. Moreover, the luminance of the whole display panel can be adjusted by setting the non-luminescence periods Er in the respective sub-pixel scanning periods and by controlling their lengths.

Moreover, according to the above-mentioned construction, the forward current passing through the elements of R, G, and B can be made common and the sub-pixels 30 of R, G, and B are respectively connected to a common data line in the respective color pixels. Hence, this makes it possible to eliminate the need for providing such a circuit for adjusting a reference current that is used in a conventional technology and to construct a power supply system of a single system and to cause one data line to respond to one color pixel. Therefore, it is possible to reduce the scale of the circuit of a display control system.

Successively, a third embodiment of the driving device and the driving method of a luminescent display panel in accordance with the present invention will be described. In this third embodiment, the general construction and the pixel construction of the driving device are nearly equal to the constructions shown in FIG. 10 and FIG. 11 in the second embodiment. Hence, in the following description, parts corresponding to the parts shown in FIG. 10 and FIG. 11 are denoted by the same reference symbols.

However, in this third embodiment, the respective color sub-pixels constructing one color pixel are not arranged on different scanning lines but are arranged on the same scanning line as shown in FIG. 13. There are provided control lines Cr, Cg, and Cb in place of the control lines C. That is, as shown in FIG. 13, the control lines Cr are connected to the sub-pixels 30 of R (red) and the control lines Cg are connected to the sub-pixels 30 of G (green) and the control lines Cb are connected to the sub-pixels 30 of B (blue). Hence, control signals are applied to the TFTs 15 for erasing of the respective sub-pixels for the respective luminescent colors via the control lines Cr, Cg, and Cb.

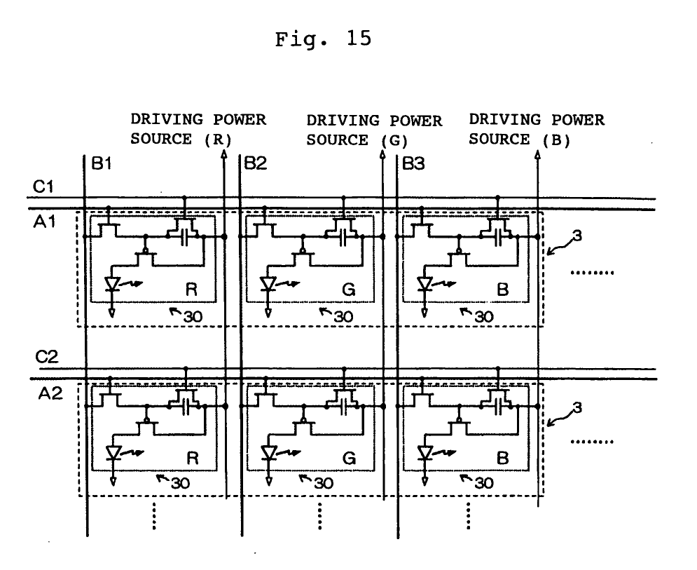

In the third embodiment, the driving device 100 performs scanning control according to a timing chart shown, for example, in FIG. 14. In an example shown in FIG. 14, one frame period is divided into sub-frame periods of equal time intervals. The scanning of the sub-pixel of R (red), the sub-pixel of G (green), and the sub-pixel of B (blue) is started at the same timing in the respective sub-frame period.

The respective non-luminescence periods Er are set for the luminescence periods of the sub-pixels of the respective colors by the action of the gate driver 26 for erasing and the TFT 15 for erasing. The lengths of the luminescence periods of the respective sub-pixels are adjusted by the lengths of the non-luminescence periods Er. The timings when the non-luminescence periods Er are started are controlled by the driving control circuit 21 (cooler balance controlling means) in such a way that a white balance (color balance) of luminescence as one color pixel becomes optimum. That is, the start timings of the non-luminescence periods Er are controlled in such a way that the ratio of relative luminescence times of the respective luminescent colors of the EL elements becomes an optimum white balance (color balance) in the sub-frame periods corresponding to the respective luminescent colors set at the same scanning timing. The driving control circuit 21 is supplied with luminance information with respect to a specified current obtained from monitor elements (not shown) corresponding to the respective colors and controls optimum scanning timings for achieving a white balance on the basis of the luminance information.

As described above, according to the third embodiment in accordance with the present invention, in the respective sub-frame periods set at the same scanning timings, the luminescence periods of the EL elements of R (red), G (green), and B (blue) are set at different lengths, and an optimum white balance can be achieved by adjusting the lengths of the respective luminescence periods by the non-luminescence periods Er.

Successively, a fourth embodiment of the driving device and the driving method of a luminescent display panel in accordance with the present invention will be described. In this fourth embodiment, the general construction and the pixel construction of the driving device are nearly equal to the constructions shown in FIG. 10 and FIG. 11 in the second embodiment. Hence, in the following description, parts corresponding to the parts shown in FIG. 10 and FIG. 11 are denoted by the same reference symbols. However, in this fourth embodiment, the respective color sub-pixels constructing one color pixel are not arranged on different scanning lines but are arranged on the same scanning line as shown in FIG. 15.

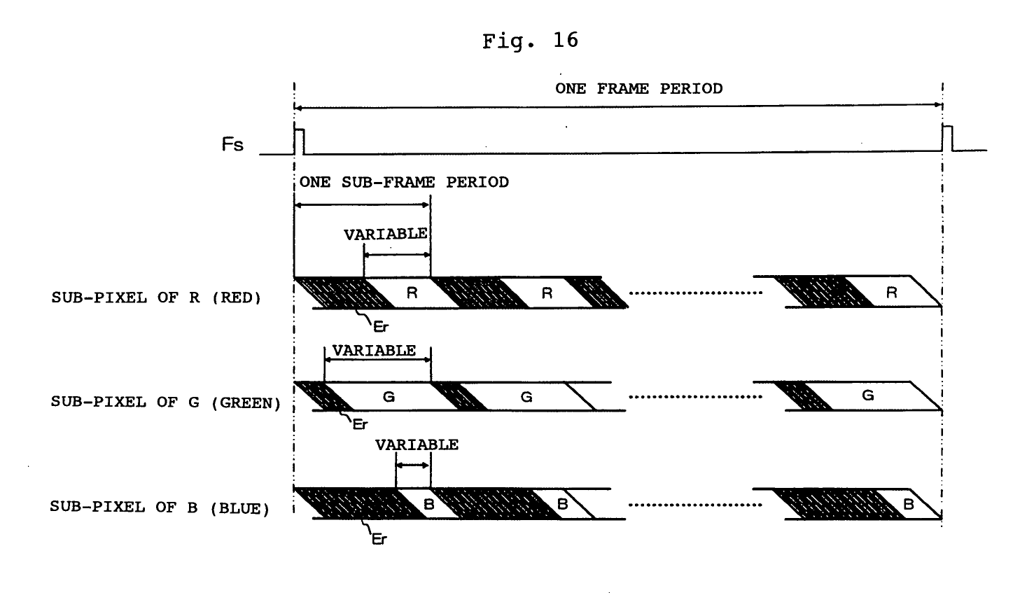

In the fourth embodiment, the driving device 100 performs scanning control according to a timing chart shown, for example, in FIG. 16. In an example shown in FIG. 16, one frame period is divided into sub-frame periods of equal time intervals. When the respective sub-frame periods are started, all of the sub-pixels constructing the same pixel are brought to a state of non-luminescence. That is, when the respective sub-frame periods are started, the non-luminescence periods Er are set for all of the color sub-pixels by the action of the gate drivers 26 for erasing and the TFTs 15 for erasing both of which act as erasing control means.

In accordance with the timing when a gate-on voltage to the TFT 11 for control is supplied to the scanning line (that is, scanning state), first, a data voltage is applied to a data line (B2 in FIG. 15) corresponding to, for example, the sub-pixels 30 of G (green). With this, the sub-pixels of G (green) start to luminesce. Next, a data voltage is applied to a data line (B1 in FIG. 15) corresponding to, for example, the sub-pixels 30 of R (red). With this, the sub-pixels of R (red) start to luminesce. Finally, a data voltage is applied to a data line (B3 in FIG. 15) corresponding to, for example, the sub-pixels 30 of B (blue). With this, the sub-pixels of B (blue) start to luminesce. The control of timing of applying the data voltage is performed by the source driver 24 and the driving control means 21 which act as data supply controlling means.

When the next sub-frame period is started, all of the sub-pixels constructing the same pixel are again brought to a state of non-luminescence by the TFTs 15.

As described above, the lengths of luminescence periods of the respective sub-pixels in the respective sub-frame periods are determined by the timings of applying the data voltages to the data lines corresponding to the respective color sub-pixels. These timings (timings when the sub-pixels of the respective luminescent colors start luminescence) are controlled by the driving control circuit 21 (color balance controlling means) in such a way that a white balance (color balance) as one color pixel becomes optimum. That is, these timings are controlled in such a way that the ratio of relative luminescence times of luminescent colors of the EL elements achieves an optimum white balance (color balance) in the respective sub-frames. The driving control circuit 21 is supplied with luminance information with respect to a specified current obtained from monitor elements corresponding to the respective colors and determines optimum luminescence starting timings for achieving a white balance on the basis of the luminance information.

As described above, according to the fourth embodiment in accordance with the present invention, all of the sub-pixels constructing the pixels are stopped from luminescing at the same time when the respective sub-frame periods start and then are made to luminesce at different timings for the respective luminescent colors. With this, the luminescence periods of the EL elements of R (red), G (green), and B (blue) are set at different lengths and an optimum white balance can be achieved by adjusting the lengths of the respective luminescence periods.

In this regard, examples in which one color pixel is constructed of three sub-pixels producing different luminescent colors have been described in the first to fourth embodiments. However, it is not intended to limit the number of colors and the number of sub-pixels to those but, for example, one pixel may be constructed of two pixels for producing different luminescent colors.

What is claimed is:

1. In a driving device of a luminescent display panel of the type in which luminescent elements each having luminescence controlled by luminescence driving means are arranged at intersecting positions of a plurality of data lines and a plurality of scanning lines and in which pixels each including a plurality of sub-pixels having different luminescent colors are arranged at the respective luminescent elements, the improvement comprising:
scanning means that scans all of the pixels formed on the luminescent display panel by scanning the sub-pixels during a plurality of sub-pixel scanning periods set at different timings for the respective luminescent colors in one frame period or in respective sub-frame periods formed by time-dividing the one frame period; and
color balance controlling means that controls a ratio of relative luminescence times of the respective different luminescent colors in the sub-pixel scanning period.

2. The driving device of a luminescent display panel as claimed in claim 1, wherein in the sub-pixel scanning periods of the respective different luminescent colors that the scanning means sets at different timings in the frame period or the sub-frame period that is fixed at a specified length, the color balance controlling means causes the sub-pixels scanned during the respective sub-pixel scanning periods to luminesce during the respective sub-pixel scanning periods.

3. The driving device of a luminescent display panel as claimed in claim 2, wherein the total sum of the lengths of the sub-pixel scanning periods of the respective different luminescent colors is equal to the length of the frame period or the sub-frame period that is fixed at the specified length.

4. The driving device of a luminescent display panel as claimed in claim 2, wherein the total sum of the lengths of the sub-pixel scanning periods of the respective different luminescent colors is shorter than to the length of the frame period or the sub-frame period that is fixed at the specified length.

5. The driving device of a luminescent display panel as claimed in claim 1, wherein the sub-pixel scanning periods of the respective different luminescent colors that the scanning means set at the respective different timings in the frame period or the sub-frame period that is fixed at a specified length are equal to each other.

6. The driving device of a luminescent display panel as claimed in claim 1, wherein the luminescence driving means includes a transistor and a transistor for erasing, which discharges and erases electric charges from a capacitor holding a gate potential of the transistor, and discharges the electric charges in the capacitor by the transistor for erasing to stop the luminescent element from luminescing to thereby set a non-luminescence period of the luminescent element in the respective sub-pixel scanning periods.

7. In a driving device of a luminescent display panel of the type in which luminescent elements each having luminescence controlled by a luminescence driving transistor are arranged at intersecting positions of a plurality of data lines and a plurality of scanning lines and in which pixels each including a plurality of sub-pixels having different luminescent colors are arranged at the luminescent elements, the improvement comprising:
scanning means that scans the sub-pixels of all of the different luminescent colors at a same start timing of scanning in the respective sub-frame periods formed by time-dividing one frame period, thereby scanning all of the pixels formed on the luminescent display panel;
a transistor for erasing that discharges and erases electric charges from a capacitor holding a gate potential of the luminescence driving transistor; and
color balance controlling means that discharges the electric charges of the capacitor by the transistor for erasing to stop the luminescent element from luminescing to set a non-luminescence period of the luminescent element in the respective sub-frame periods, thereby controlling a ratio of relative luminescence times of the respective different luminescent colors in the respective sub-pixel scanning periods.

8. In a driving device of a luminescent display panel of the type in which luminescent elements each having luminescence controlled by a luminescence driving transistor are arranged at intersecting positions of a plurality of data lines and a plurality of scanning lines and in which pixels each including a plurality of sub-pixels having different luminescent colors are arranged at the luminescent elements, the improvement comprising:
luminescence stop controlling means that stops the luminescent element from luminescing by using a transistor for erasing that discharges and erases electric charges from a capacitor holding a gate potential of the luminescence driving transistor;
data supply controlling means that applies a data voltage to the data lines corresponding to the sub-pixels having different luminescent colors, which construct a same pixel, at different timings for respective luminescent colors in respective sub-frame periods formed by time-dividing one frame period; and
color balance controlling means that stops the luminescent elements of the sub-pixels of the respective different luminescent colors from luminescing by the luminescence stop controlling means when the respective sub-frame periods start to thereby set a non-luminescence period of the pixel when the respective sub-frame periods start, and controls timing of applying the data voltage by the data supply control means to cause the sub-pixels to start to luminesce for the respective luminescent colors, thereby controlling a ratio of relative luminescence times of the respective different luminescent colors in the respective sub-frame periods.

9. The driving device of a luminescent display panel as claimed in any one of claims 1, 7, and 8, wherein the luminescent element is an organic EL element including at least one layer or more of organic luminescent function layer.

10. In a driving method of a luminescent display panel of the type in which luminescent elements each having luminescence controlled by luminescence driving means are arranged at intersecting positions of a plurality of data lines and a plurality of scanning lines and in which pixels each including a plurality of sub-pixels having different luminescent colors are arranged at the luminescent elements, the improvement comprising the steps of:
scanning all of the pixels formed on the luminescent display panel by scanning the sub-pixels during a plurality of sub-pixel scanning periods set at different timings for the respective luminescent colors in one frame period or in respective sub-frame periods formed by time-dividing the one frame period; and
controlling a ratio of relative luminescence times of the respective different luminescent colors in the sub-pixel scanning period.

11. The driving method of a luminescent display panel as claimed in claim 10, comprising the step of causing the sub-pixels scanned during the respective sub-pixel scanning periods of the respective different luminescent colors, which are set in the frame period or the sub-frame period that is fixed at a specified length, to luminesce during the sub-pixel scanning periods.

12. The driving method of a luminescent display panel as claimed in claim 11, wherein the total sum of the lengths of the sub-pixel scanning periods of the respective different luminescent colors is equal to the length of the frame period or the sub-frame period that is fixed at the specified length.

13. The driving method of a luminescent display panel as claimed in claim 11, wherein the total sum of the lengths of the sub-pixel scanning periods of the respective different luminescent colors is shorter than the length of the frame period or the sub-frame period that is fixed at the specified length.

14. The driving device of a luminescent display panel as claimed in claim 10, wherein the sub-pixel scanning periods of the respective different luminescent colors, which are set at the respective different timings in the frame period or the sub-frame period that is fixed at a specified length are equal to each other.

15. The driving method of a luminescent display panel as claimed in claim 10, wherein the luminescence driving means includes a transistor and a transistor for erasing, which discharges and erases electric charges from a capacitor holding a gate potential of the transistor, and performs the step of discharging electric charges from the capacitor by the transistor for erasing, thereby stopping the luminescent element from luminescing, and thereby setting a non-luminescence period of the luminescent element in the respective sub-pixel scanning periods.

16. In a driving method of a luminescent display panel of the type in which luminescent elements each having luminescence controlled by a luminescence driving transistor are arranged at intersecting positions of a plurality of data lines and a plurality of scanning lines and in which pixels each including a plurality of sub-pixels having different luminescent colors are arranged at the luminescent elements, the improvement comprising the steps of:
scanning the sub-pixels of all of the different luminescent colors at a same start timing of scanning in the respective sub-frame periods formed by time-dividing one frame period, thereby scanning all of the pixels formed on the luminescent display panel; and
stopping the luminescent element from luminescing for the respective different luminescent colors by a transistor for erasing that discharges and erases electric charges from a capacitor holding a gate potential of the luminescence driving transistor in the respective sub-frame periods, thereby setting a non-luminescence period, and thereby controlling a ratio of relative luminescence times of the respective different luminescent colors in the respective sub-pixel scanning periods.

17. In a driving method of a luminescent display panel of the type in which luminescent elements each having luminescence controlled by a luminescence driving transistor are arranged at intersecting positions of a plurality of data lines and a plurality of scanning lines and in which pixels each including a plurality of sub-pixels having different luminescent colors are arranged at the luminescent elements, the improvement comprising the steps of:
stopping the luminescent elements of the sub-pixels of the respective different luminescent colors from luminescing at a same time by using a transistor for erasing that discharges and erases electric charges from a capacitor holding a gate potential of the luminescence driving transistor when the respective sub-frame periods formed by time-dividing one frame period start, thereby setting a non-luminescence period of the pixel when the respective sub-frame periods start; and
controlling timing of applying a data voltage to data lines corresponding to the respective different luminescent colors for the sub-pixels of respective different luminescent colors, which construct a same pixel, in the respective sub-frame periods, thereby causing the sub-pixels to start to luminesce for the respective luminescent colors, and thereby controlling a ratio of relative luminescence times of the respective different luminescent colors in the respective sub-frame periods.
